(19) United States
(12) Patent Application Publication
(10) Pub. No.: US 2025/0088375 A1
(43) Pub. Date: Mar. 13, 2025

(54) SYSTEM AND METHOD FOR STORING IMMUTABLE EVIDENCE DATA

(71) Applicant: The Toronto-Dominion Bank, Toronto (CA)

(72) Inventor: A. Warren PRATTEN, London (CA)

(73) Assignee: The Toronto-Dominion Bank, Toronto, ON (CA)

(21) Appl. No.: 18/463,408

(22) Filed: Sep. 8, 2023

(51) Int. Cl. H04L 9/00; G06Q 20/38

(52) U.S. Cl. CPC H04L 9/50; G06Q 20/389

(57) ABSTRACT

A server computer system comprises a communications module; a processor coupled to the communications module; and a memory coupled to the processor, the memory storing processor-executable instructions which, when executed, configure the processor to obtain, via the communications module, immutable evidence data; mint the immutable evidence data as a non-fungible token that includes metadata identifying at least a date of creation of the non-fungible token; and store the non-fungible token in a block of a blockchain network.

### TECHNICAL FIELD

The present application relates to a system and method for storing immutable evidence data.

### BACKGROUND

Disputes may arise and historical computer data may be stored and retrieved to resolve these disputes. It is often difficult to determine if the historical computer data was tampered with.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a schematic operation diagram illustrating a blockchain network of an example embodiment;

FIG. 3 is a simplified diagram showing components of an example automated teller machine;

FIG. 4 is a logical block diagram of the example automated teller machine of FIG. 3;

FIG. 5 is a high-level operation diagram of an example computing device;

FIG. 6 depicts an example simplified software organization of the example computing device of FIG. 5;

FIG. 7 is a flowchart showing operations performed in storing immutable evidence data according to an embodiment;

FIG. 8 is a flowchart showing operations performed in aggregating automated teller machine session data;

FIG. 9 is a flowchart showing operations performed in verifying immutable evidence data;

FIGS. 10 to 21 show example immutable evidence data that includes automated teller machine session data in the form of screenshots, screen stills and images; and

FIGS. 22 and 23 show example immutable evidence data that includes consent data in the form of screenshots.

Like reference numerals are used in the drawings to denote like elements and features.

### DETAILED DESCRIPTION OF VARIOUS EMBODIMENTS

Accordingly, in one aspect there is provided a server computer system comprising a communications module; a processor coupled to the communications module; and a memory coupled to the processor, the memory storing processor-executable instructions which, when executed, configure the processor to obtain, via the communications module, immutable evidence data; mint the immutable evidence data as a non-fungible token that includes metadata identifying at least a date of creation of the non-fungible token; and store the non-fungible token in a block of a blockchain network.

In one or more embodiments, the metadata is stored off-chain.

In one or more embodiments, the metadata is stored as a Uniform Resource Identifier link inside a contract of the non-fungible token.

In one or more embodiments, the metadata includes information identifying a date of modification of the non-fungible token.

In one or more embodiments, when minting the immutable evidence data as the non-fungible token, the instructions, when executed, further configure the processor to create a new token having a unique token identifier; and associate the new token with the metadata.

In one or more embodiments, the instructions, when executed, further configure the processor to receive a request to verify the immutable evidence data; retrieve the non-fungible token from the blockchain network; and analyze the metadata of the non-fungible token to determine at least one of the date of creation of the non-fungible token or a date of modification of the non-fungible token to verify the immutable evidence data.

In one or more embodiments, the non-fungible token includes a static non-fungible token.

In one or more embodiments, the immutable evidence data includes at least one of consent data or automated teller machine session data.

In one or more embodiments, the immutable evidence data includes automated teller machine session data and the automated teller machine session data is obtained, via the communications module, from at least one automated teller machine data source that includes at least one of an automated teller machine, an automated teller machine switch, and an automated teller machine host server.

In one or more embodiments, the at least one automated teller machine data source includes a plurality of automated teller machine data sources and the processor-executable instructions, when executed, further configure the processor to normalize and aggregate the automated teller machine session data.

In one or more embodiments, when aggregating the automated teller machine session data, the processor-executable instructions, when executed, further configure the processor to analyze the automated teller machine session data to identify at least one commonality within the automated teller machine session data received from each of the automated teller machine data sources; and aggregate the automated teller machine session data based at least on the identified commonality.

According to another aspect there is provided a computer-implemented method performed by a processor of a server computer system, the method comprising obtaining, via a communications module, immutable evidence data; minting the immutable evidence data as a non-fungible token that includes metadata identifying at least a date of creation of the non-fungible token; and storing the non-fungible token in a block of a blockchain network.

In one or more embodiments, the metadata is stored off-chain.

In one or more embodiments, the metadata is stored as a Uniform Resource Identifier link inside a contract of the non-fungible token.

In one or more embodiments, the metadata includes information identifying a date of modification of the non-fungible token.

In one or more embodiments, when minting the immutable evidence data as the non-fungible token, the method further comprises creating a new token having a unique token identifier; and associating the new token with the metadata.

In one or more embodiments, the method further comprises receiving a request for the immutable evidence data; retrieving the non-fungible token from the blockchain network; and analyzing the non-fungible token to determine at least one of the date of creation of the non-fungible token or a date of modification of the non-fungible token.

In one or more embodiments, the immutable evidence data includes at least one of consent data or automated teller machine session data.

In one or more embodiments, the immutable evidence data includes automated teller machine session data and the automated teller machine session data is obtained, via the communications module, from at least one automated teller machine data source that includes at least one of an automated teller machine, an automated teller machine switch, and an automated teller machine host server.

According to another aspect there is provided a non-transitory computer-readable storage medium storing instructions that when executed by a processor of a computing system cause the computing system to obtain, via a communications module, immutable evidence data; mint the immutable evidence data as a non-fungible token that includes metadata identifying at least a date of creation of the non-fungible token; and store the non-fungible token in a block of a blockchain network.

Aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

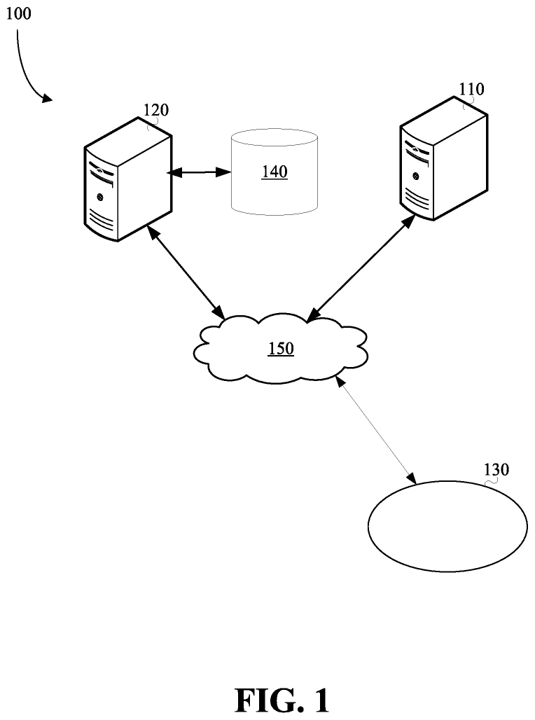

FIG. 1 is a schematic operation diagram illustrating an operating environment of an example embodiment. As shown, a system 100 includes an immutable evidence data provider 110, a server computer system 120, and a blockchain network 130 coupled to one another through a network 150, which may include a public network such as the Internet and/or a private network. The immutable evidence data provider 110, the server computer system 120, and the blockchain network 130 may be in geographically disparate locations. Put differently, the immutable evidence data provider 110, the server computer system 120, and the blockchain network 130 may be located remote from one another.

In one or more embodiments, the immutable evidence data provider 110 may include a server computer system adapted to provide consent data such as for example screenshots, videos, etc. of a user providing consent such as for example opt-in consent.

In one or more embodiments, the immutable evidence data provider 110 may include an automated teller machine adapted to provide access to banking services such as, for example, withdrawals and deposits. The automated teller machine may be configured to capture images of at least some of the value instruments it receives. The automated teller machine may be associated with a financial institution.

The server computer system 120 is a computer server system. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

In one or more embodiments, the server computer system 120 may be associated with a financial institution and the financial institution may be the same financial institution associated with the automated teller machine.

The server computer system 120 may be associated with or may communicate with a database 140 that stores data records. The data records may include, for example, immutable evidence data received or obtained from the immutable evidence data provider 110.

The network 150 is a computer network. In some embodiments, the network 150 may be an internetwork such as may be formed of one or more interconnected computer networks. For example, the network 150 may be or may include an Ethernet network, an asynchronous transfer mode (ATM) network, a wireless network, a telecommunications network, or the like.

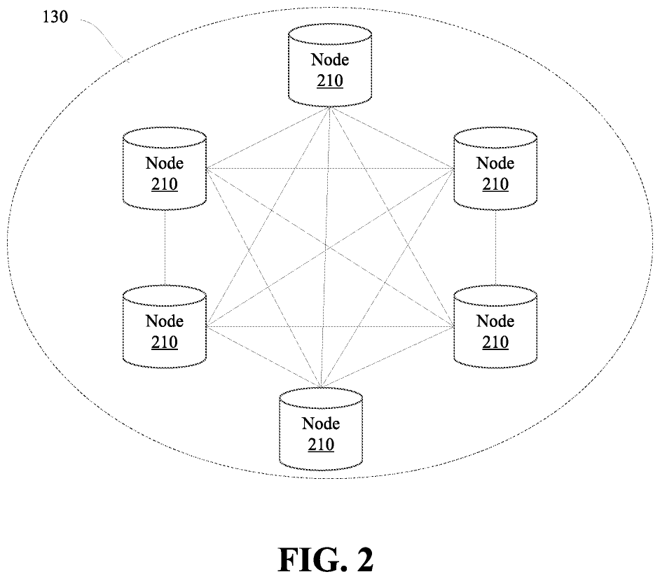

An example of the blockchain network 130 is shown in FIG. 2. The blockchain network 130 may include a peer-to-peer open membership network which may be joined by anyone, without invitation or without consent from other members. Distributed electronic devices running an instance of the blockchain protocol under which the blockchain network 130 operates may participate in the blockchain network 130. Such distributed electronic devices may be referred to as nodes 210. The blockchain protocol may be an Ethereum protocol, or another cryptocurrency, for example.

The electronic devices that run the blockchain protocol and that form the nodes 210 of the blockchain network 130 may be of various types including, for example, computers such as desktop computers, laptop computers, tablet computers, servers, mobile devices such as smartphones, wearable computers such as smart watches or other electronic devices.

Nodes 210 of the blockchain network 130 are coupled to one another using suitable communication technologies which may include wired and wireless communication technologies. In many cases, the blockchain network 130 is implemented at least partly over the Internet, and some of the nodes 210 may be located in geographically dispersed locations.

Nodes 210 maintain a global ledger of all transactions on the blockchain, grouped into blocks, each of which contains a hash of the previous block in the chain. The global ledger is a distributed ledger and each node 210 may store a complete copy or a partial copy of the global ledger. Transactions by a node 210 affecting the global ledger are verified by other nodes 210 so that the validity of the global ledger is maintained. The details of implementing and operating a blockchain network, such as one using the Ethereum protocol, will be appreciated by those ordinarily skilled in the art.

Each transaction typically has one or more inputs and one or more outputs. Scripts embedded into the inputs and outputs specify how and by whom the outputs of the transactions can be accessed. The output of a transaction may be an address to which value (or a digital asset) is transferred as a result of the transaction. That value is then associated with that output address as an unspent transaction output (UTXO). A subsequent transaction may then reference that address as an input in order to spend or disperse that value.

Nodes 210 can fulfill numerous different functions, from network routing to wallet services, to maintain a robust and secure decentralized public ledger. “Full nodes” contain a complete and up-to-date copy of the blockchain, and can therefore verify any transactions (spent or unspent) on the public ledger. “Lightweight nodes” (or SPV) maintain a subset of the blockchain and can verify transactions using a “simplified payment verification” technique. Lightweight nodes only download the headers of blocks, and not the transactions within each block. These nodes therefore rely on peers to verify their transactions. “Mining nodes”, which can be full or lightweight nodes, are responsible for validating transactions and creating new blocks on the blockchain. “Wallet nodes”, which are typically lightweight nodes, handle wallet services of users. Nodes 210 communicate with each other using a connection-oriented protocol, such as TCP/IP (Transmission Control Protocol).

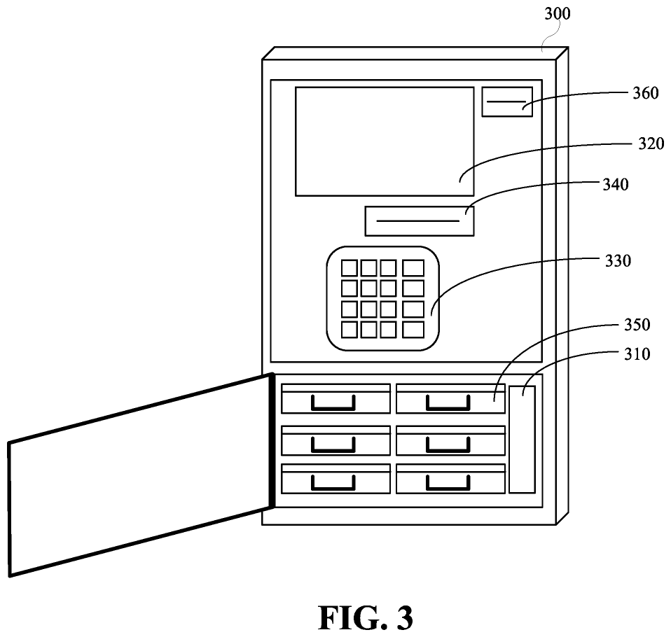

As mentioned, in one or more embodiments the immutable evidence data provider 110 includes an automated teller machine. FIG. 3 illustrates example components of an automated teller machine 300. The automated teller machine 300 is adapted to provide access to banking services such as for example withdrawals and deposits. As shown in FIG. 3, the automated teller machine 300 includes a controller 310, a display 320, a keypad 330, an item receiver/dispenser 340, cassettes 350, and a card reader 360.

As further described below, the controller 310 is a computing device. For example, the controller 310 may include at least one processor that executes instructions retrieved from a computer-readable medium thereby causing the automated teller machine 300 to perform operations for providing access to banking services.

The display 320 may for example, be a liquid-crystal display (LCD), a cathode-ray tube (CRT), or the like. The display 320 may present a user interface to a user of the automated teller machine 300.

The keypad 330 is an input device allowing input to be provided to the automated teller machine 300. Input received via the keypad 330 may be conveyed to the controller 310. The keypad 330 may be used by a user to provide a personal identification number (PIN) to the automated teller machine 300 as a part of authenticating to the automated teller machine 300.

The item receiver/dispenser 340 is a device allowing value instruments to be received by the automated teller machine 300 or dispensed by the automated teller machine 300. The value instruments may include banknotes and/or cheques. The item receiver/dispenser 340 may provide a single slot through which value instruments may be dispensed. Additionally or alternatively, the item receiver/dispenser 340 may provide multiple slots. It may be that components or units of the item receiver/dispenser 340 are specialized to a particular type or types of value instrument. For example, a particular component or unit of the item receiver/dispenser 340 may be adapted to receiving and/or dispensing banknotes of one denomination, while another component or unit may be adapted to receiving and/or dispensing banknotes of another denomination. Alternatively, it may be that the item receiver/dispenser 340 is a monolithic unit that handles all manner of value instruments.

As mentioned above, the automated teller machine includes one or more cassettes 350. The item receiver/dispenser 340 may be in communication with the cassettes 350. Some or all of the cassettes 350 may be adapted to dispense value instruments. For example, some of the cassettes 350 may be for dispensing banknotes of particular denominations.

The item receiver/dispenser 340 and the cassettes 350 may be collectively considered a value instrument dispenser adapted to dispense value instruments such as to satisfy withdrawals from the automated teller machine 300.

The card reader 360 allows data to be read from a card or access card such as for example a common ISO-sized ATM or cheque card. For example, the card reader 360 may allow data to be read from magnetic stripe cards and/or chip cards. In some embodiments, the card reader 360 may require a card to be swiped through it to be read (a so-called “swipe reader”) and/or it may allow a card to be inserted into it for reading (a so-called “dip reader”). In some embodiments, the card reader 360 may be adapted to allow inserted cards to be retained by the automated teller machine 300 indefinitely (such as if fraud is suspected) and/or for the period of a session.

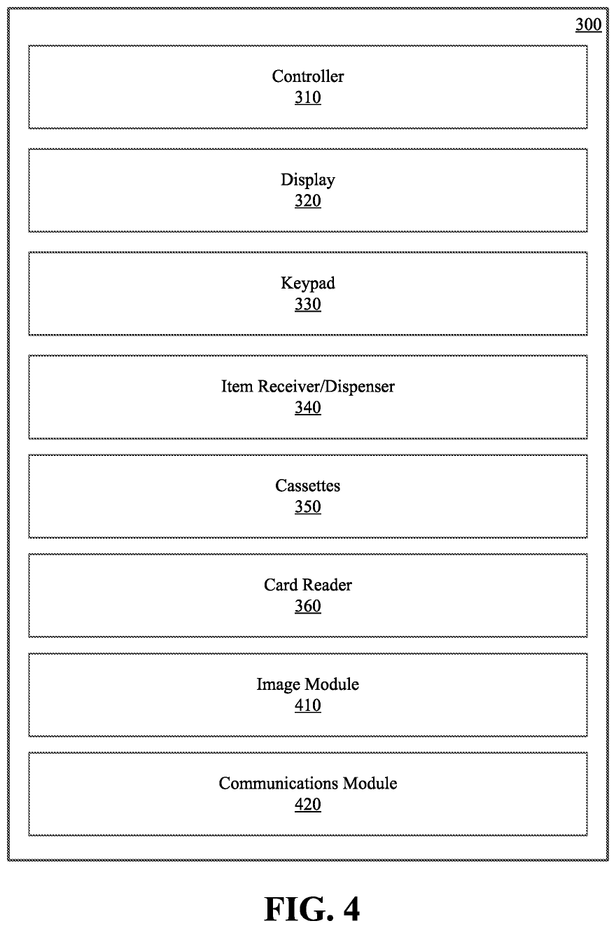

FIG. 4 is a logical block diagram of the automated teller machine 300. As described above, the automated teller machine 300 may include a controller 310, a display 320, a keypad 330, an item receiver/dispenser 340, cassettes 350, and a card reader 360 as described above. Additionally, as shown in FIG. 4, the automated teller machine 300 may include an image module 410 and a communications module 420.

The image module 410 is adapted to scan or capture images of value instruments received by the automated teller machine 300. For example, the image module 410 may scan or capture images of value instruments (such as, for example, bank notes, negotiable instruments like cheques, money orders, bank drafts, warrants of payment, etc.) as they are received by the automated teller machine 300 such as, for example, by way of the item receiver/dispenser 340. The image module 410 may include a colour, black and white, or a grayscale scanner. In one or more embodiments, image module 410 may include an ultraviolet scanner and the ultraviolet scanner may be engaged to identify security features for counterfeit detection. The image module 410 may include a number of scanning technologies. For example, the image module 410 may include a contact image sensor (CIS), a charge-coupled device (CCD), etc.

The communications module 420 allows the automated teller machine 300 to communicate with other computing devices and/or various communications networks such as, for example, the network 150. In other words, the communications module 420 may allow the automated teller machine 300 to send or receive communications signals. Communications signals may be sent or received according to one or more protocols or according to one or more standards. For example, the communications module 420 may allow the automated teller machine 300 to communicate via an Ethernet network, an ATM network, a telephone network, and/or via cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 420 may allow the automated teller machine 300 to communicate using near-field communication (NFC), via Wi-Fi™, using Bluetooth™ or via some combination of one or more networks or protocols.

In embodiments where the immutable evidence data provider 110 includes the automated teller machine, the system 100 may additionally include an automated teller machine switch. The automated teller machine switch may be adapted to broker (e.g., relay) communication between the automated teller machine and a payment network. The automated teller machine switch may perform operations related to performing transactions using the automated teller machine. For example, the automated teller machine switch may perform operations related to authorizing and/or completing transactions based on cheques deposited at the automated teller machine. The automated teller machine switch may additionally or alternatively perform operations related to authenticating a user of the automated teller machine. For example, the automated teller machine switch may perform operations to authenticate a user based on data from a card used to access the automated teller machine and based on a personal identification number (PIN) received as input by the automated teller machine.

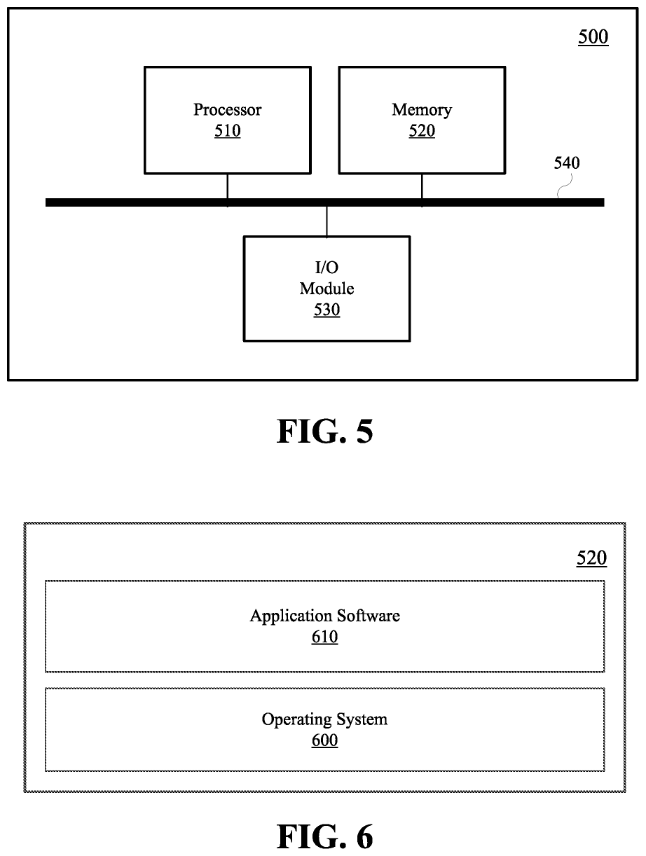

FIG. 5 is a high-level operation diagram of an example computing device 500. In some embodiments, the example computing device 500 may be exemplary of the immutable evidence data provider 110 and/or the server computer system 120. In embodiments where the immutable evidence data provider 110 includes the automated teller machine 300, the example computing device 500 may be exemplary of the controller 310 of the automated teller machine 300 and/or the automated teller machine switch.

The immutable evidence data provider 110, the server computer system 120, the automated teller machine 300 and/or the automated teller machine switch include software that adapts it to perform a particular function.

The example computing device 500 includes a variety of modules. For example, as illustrated, the example computing device 500 may include a processor 510, a memory 520, and an input/output (I/O) module 530. As illustrated, the foregoing example modules of the example computing device 500 are in communication over a bus 540.

The processor 510 is a hardware processor. The processor 510 may, for example, be one or more ARM, Intel x86, PowerPC processors or the like.

The memory 520 allows data to be stored and retrieved. The memory 520 may include, for example, random access memory, read-only memory, and persistent storage. Persistent storage may be, for example, flash memory, a solid-state drive or the like. Read-only memory and persistent storage are non-transitory computer-readable storage mediums. A computer-readable medium may be organized using a file system such as may be administered by an operating system governing overall operation of the example computing device 500.

The I/O module 530 allows the example computing device 500 to interact with devices such as, for example, peripherals to send and receive data. The I/O module 530 may, for example, allow the example computing device 500 to interface with input devices such as, for example, keypads, keyboards, pointing devices, and the like. In another example, the I/O module 530 may, for example, allow the example computing device 500 to interface with output devices such as, for example, displays, printers, and the like. In a particular example, where the example computing device 500 forms a part of the automated teller machine 300, such as for example, if the example computing device 500 is or forms a part of the controller 310 (FIG. 3) of the automated teller machine 300, the I/O module 530 may allow the example computing device 500 to interface with, for example, one or more of the display 320, the keypad 330, the item receiver/dispenser 340, cassettes 350, the card reader 360, the image module 410 and/or the communications module 420.

Software comprising instructions is executed by the processor 510 from a computer-readable medium. For example, software may be loaded into random-access memory from persistent storage of the memory 520. Additionally, or alternatively, instructions may be executed by the processor 510 directly from read-only memory of the memory 520.

FIG. 6 depicts a simplified organization of software components stored in the memory 520 of the example computing device 500 (FIG. 5). As illustrated, these software components include an operating system 600 and application software 610.

The operating system 600 is software. The operating system 600 allows the application software 610 to access the processor 510, the memory 520, and the I/O module 530 of the example computing device 500 (FIG. 5). The operating system 600 may be, for example, Google™ Android™, Apple™ iOS™, UNIX™, Linux™, Microsoft™ Windows™, Apple OSX™ or the like.

The application software 610 adapts the example computing device 500, in combination with the operating system 600, to operate as a device performing a particular function. For example, the application software 610 may cooperate with the operating system 600 to adapt a suitable embodiment of the example computing device 500 to operate as the controller 310 (FIG. 3) of the automated teller machine 300 (FIG. 3).

The server computer system 120 may receive and store immutable evidence data received or obtained from the immutable evidence data provider 110.

In one or more embodiments, the immutable evidence data may include consent data. Operations performed by the immutable evidence data provider 110 to generate the consent data will now be described.

The immutable evidence data provider 110 may communicate one or more requests for consent to an electronic device such as for example a mobile device or a personal computer. In one or more embodiments, the requests may include requests for opt-in consent to receive electronic communications such as emails, text messages, etc. In one or more embodiments, the requests may include requests to consent to a particular interest rate. For example, a user may be submitting a request for a mortgage using the electronic device and may consent to locking in a particular interest rate for a term of ninety (90) days. In one or more embodiments, the requests may include requests to consent to terms and/or conditions of a legal contract. For example, the electronic device may display a terms and conditions page and may prompt the user to consent to the terms and conditions.

The user of the electronic device may perform operations to consent to the one or more requests. For example, a graphical user interface may be displayed on the electronic device that includes a selectable option to provide the consent. The user may select the selectable option by, for example, performing a tap gesture on a display screen of the electronic device at a location that corresponds to the location of the selectable option. The user may select a selectable option to submit the consent and in response the electronic device may submit consent data to the immutable evidence data provider 110. In turn, the immutable evidence data provider 110 may communicate the consent data to the server computer system 120.

In one or more embodiments where the immutable evidence data provider 110 includes the automated teller machine 300, the immutable evidence data may include automated teller machine session data. Operations performed by the automated teller machine 300 to generate the automated teller machine data will now be described.

The automated teller machine 300 may perform one or more tasks associated with an account. Prior to performing the one or more tasks, the automated teller machine 300 may require a user to authenticate using, for example, an authentication token. Authentication may include receiving an indication of an authentication token and authenticating the authentication token. In one or more embodiments, authenticating may require two-factor authentication. For example, in one or more embodiments, the automated teller machine 300 may require the user to enter a PIN associated with the card that was inserted into the card reader 360. The user may enter the PIN using, for example, the keypad 330 of the automated teller machine 300. Responsive to receiving the PIN, the automated teller machine 300 may determine that the PIN is indeed associated or linked with the card. Once authenticated, the automated teller machine 300 may identify an account associated with the authentication token.

Once authentication has been completed, an automated teller machine session begins. During the automated teller machine session, the automated teller machine 300 may perform one or more tasks associated with the account. The tasks may include depositing funds, withdrawing funds, determining an account balance, etc.

During the automated teller machine session, the automated teller machine 300 may log and store automated teller machine session data. The automated teller machine session data may include one or more of data indicating actions performed by the customer at the automated teller machine 300 and in what order, screenshots of images presented to the customer during the automated teller machine session such as for example a screenshot showing the presentation of a disclosure statement, images of cheque deposits, data indicating hardware or software faults that took place at the automated teller machine 300 during the automated teller machine session, the automated teller machine 300 terminal identification, a time of the automated teller machine session, a date of the automated teller machine session, a customer identifier, account identifiers, amounts of funds withdrawn or deposited during the automated teller machine session, data indicating customer decisions made based on the presented disclosure screens, and/or an image of a transaction receipt (regardless of whether or not the customer has requested a receipt) for one or more transactions completed during the automated teller machine session. The automated teller machine session data is logged from the beginning of the automated teller machine session (once authentication has been completed) to the end of the automated teller machine session (when the card has been returned to the customer).

In turn, the automated teller machine may communicate the automated teller machine session data to the server computer system 120.

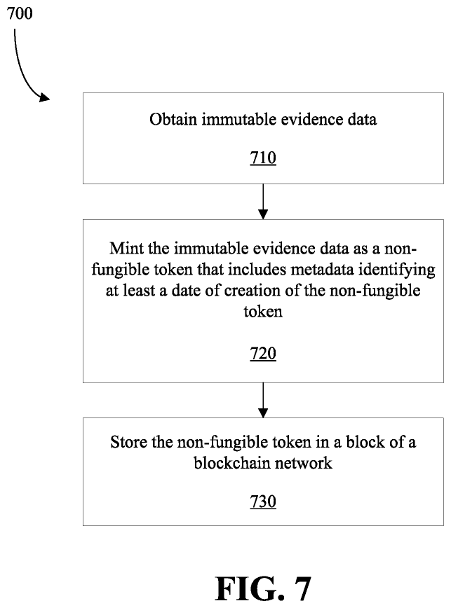

The server computer system 120 performs operations to store the immutable evidence data. Reference is made to FIG. 7, which illustrates, in flowchart form, a method 700 for storing immutable evidence data. The method 700 may be implemented by a computing device having suitable processor-executable instructions for causing the computing device to carry out the described operations. The method 700 may be implemented, in whole or in part, by the server computer system 120.

The method 700 includes obtaining immutable evidence data (step 710).

In one or more embodiments, the immutable evidence data may be obtained from the immutable evidence data provider 110. For example, the immutable evidence data provider 110 may communicate the immutable evidence data to the server computer system 120. In one or more embodiments, the immutable evidence data may be sent to the server computer system 120 at set intervals. For example, at the end of each business day, the immutable evidence data provider 110 may send all immutable evidence data collected that day to the server computer system 120 for storage. The immutable evidence data may include a single image, screenshot, video file, etc. or may include a number or collection of data such as a group or sequence of images or screenshots, video files, etc.

In embodiments where the immutable evidence data includes automated teller machine session data, the automated teller machine data may be obtained via the network 150 from a single source and the single source may include the automated teller machine 300. As mentioned, the automated teller machine session data may include one or more of data indicating actions performed by the customer at the automated teller machine 300 and in what order, screenshots of images presented to the customer during the automated teller machine session such as for example a screenshot showing the presentation of a disclosure statement, images of cheque deposits, data indicating hardware or software faults that took place at the automated teller machine 300 during the automated teller machine session, the automated teller machine 300 terminal identification, a time of the automated teller machine session, a date of the automated teller machine session, a customer identifier, account identifiers, amounts of funds withdrawn or deposited during the automated teller machine session, data indicating customer decisions made based on the presented disclosure screens, and/or an image of a transaction receipt (regardless of whether or not the customer has requested a receipt) for one or more transactions completed during the automated teller machine session.

In one or more embodiments, the automated teller machine session data may be obtained from the single source at the end of an automated teller machine session. For example, an automated teller machine session may begin when a card is inserted into the automated teller machine 300 and the automated teller machine session may end when the card is returned by the automated teller machine 300. As another example, an automated teller machine session may begin once authentication has been completed (as described above) and may end when the card is returned by the automated teller machine 300.

In one or more embodiments, the automated teller machine session data may be sent to the server computer system 120 in batches. For example, the automated teller machine 300 may send automated teller machine session data to the server computer system 120 at the end of every hour, every day, etc. In this example, the automated teller machine session data may include automated teller machine session data for a plurality of automated teller machine sessions.

In one or more embodiments, the automated teller machine session data may be obtained via the network 150 from a plurality of automated teller machine session data sources. The plurality of automated teller machine data sources may include an automated teller machine, an automated teller machine switch and/or an automated teller machine host server.

In one or more embodiments, automated teller machine session data obtained from the automated teller machine may include one or more of data indicating actions performed by the customer at the automated teller machine 300 and in what order, screenshots of images presented to the customer during the automated teller machine session such as for example a screenshot showing the presentation of a disclosure statement, images of cheque deposits, data indicating hardware or software faults that took place at the automated teller machine 300 during the automated teller machine session, the automated teller machine 300 terminal identification, a time of the automated teller machine session, a date of the automated teller machine session, a customer identifier, account identifiers, amounts of funds withdrawn or deposited during the automated teller machine session, data indicating customer decisions made based on the presented disclosure screens, and/or an image of a transaction receipt (regardless of whether or not the customer has requested a receipt) for one or more transactions completed during the automated teller machine session.

In one or more embodiments, automated teller machine session data obtained from the automated teller machine switch may include financial transaction data based on communications exchanged via the automated teller machine switch. The financial transaction data may include, for example, data indicating whether a transaction was approved or denied, a service charge applied for a transaction, an exchange rate used to complete a transaction, etc.

In one or more embodiments, automated teller machine session data obtained from the automated teller machine host server may include financial transaction data based on communications exchanged via the automated teller machine host server. The financial transaction data may include, for example, data indicating whether a transaction was approved or denied, a service charge applied for a transaction, an exchange rate used to complete a transaction, etc.

It will be appreciated that the automated teller machine session data obtained from the automated teller machine switch may align with the automated teller machine session data obtained from the automated teller machine host server.

The automated teller machine session data may additionally be obtained from, for example, a security server computer system. In this example, the automated teller machine session data may include surveillance video or surveillance images taken by one or more security cameras located in proximity with the automated teller machine 300.

In embodiments where the server computer system 120 obtains automated teller machine session data from a plurality of automated teller machine session data sources, the server computer system 120 may analyze the automated teller machine session data to normalize and aggregate the automated teller machine session data for each automated teller machine session.

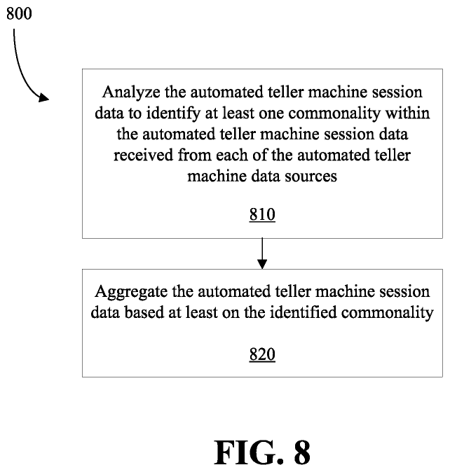

Reference is made to FIG. 8, which illustrates, in flowchart form, a method 800 for aggregating automated teller machine session data. The method 800 may be implemented by a computing device having suitable processor-executable instructions for causing the computing device to carry out the described operations. The method 800 may be implemented, in whole or in part, by the server computer system 120.

The method 800 includes analyzing the automated teller machine session data to identify at least one commonality within the automated teller machine session data received from each of the automated teller machine data sources (step 810).

The server computer system 120 analyzes the automated teller machine session data received from the plurality of automated teller machine session data sources to identify at least one commonality. The at least one commonality may include one or more of a transaction identifier, a time, a date, an automated teller machine identifier, a customer identifier, or an account identifier. The at least one commonality may be identified, for example, by analyzing metadata associated with the automated teller machine session data or may be identified directly from the automated teller machine session data.

In one or more embodiments, automated teller machine session data received from one or more of the automated teller machine session data sources may not have the same commonality as other automated teller machine session data sources. For example, the server computer system 120 may identify a commonality such as a transaction identifier in automated teller machine session data obtained from the automated teller machine, the automated teller machine switch, and the automated teller machine host server. The transaction identifier may not however be available for the automated teller machine session data obtained from the security server computer system. However, the time and the date may be obtained from the automated teller machine session data obtained from the security server computer system and as such the time and the date may be used to aggregate the automated teller machine session data obtained from the security server computer system with the automated teller machine session data obtained from the automated teller machine, the automated teller machine switch, and the automated teller machine host server.

The method 800 includes aggregating the automated teller machine session data based at least on the identified commonality (step 820).

The automated teller machine session data identified is aggregated for the automated teller machine session. In one or more embodiments, aggregating the automated teller machine session data may include generating a data file that includes all the automated teller machine session data obtained for the automated teller machine session. The data file may include a compressed data file that may be generated using a data compression engine that utilizes one or more data compression algorithms.

It will be appreciated that operations of the method 800 may be similarly performed in embodiments where the immutable evidence data includes consent data. For example, consent data may be received from multiple sources and may be analyzed to identify at least one commonality such as for example a name, email address, etc. The consent data may be aggregated based at least on the commonality.

Referring back to FIG. 7, the method 700 includes minting the immutable evidence data as a non-fungible token that includes metadata identifying at least a date of creation of the non-fungible token (step 720).

The server computer system 120 mints the non-fungible token by converting the immutable evidence data into a digital asset.

In one or more embodiments, the non-fungible token may be created using an Ethereum Request for Comments 721 (ERC-721) compliant smart contract interface.

In one or more embodiments the non-fungible token may include a static non-fungible token, that is, a non-fungible token that cannot be modified in any way. In one or more embodiments, the non-fungible token may include a dynamic non-fungible token that may be modified.

The non-fungible token is minted to include metadata. The metadata identifies a date of creation of the non-fungible token. The metadata may additionally include a date of modification of the non-fungible token and this may be automatically updated in the event that the non-fungible token is modified. It will be appreciated that the metadata may include the date of modification only when the non-fungible token includes the dynamic non-fungible token.

In one or more embodiments, the metadata may be stored off-chain. For example, the metadata may be stored as a Uniform Resource Identifier link inside a contract of the non-fungible token.

The non-fungible token may be assigned a unique token identifier. The unique token identifier may be associated with the metadata.

The method 700 includes storing the non-fungible token in a block of a blockchain network (step 730).

Responsive to minting the non-fungible token, the server computer system 120 may store the non-fungible token in a block of the blockchain network. The non-fungible token may be stored together with the metadata on the blockchain network.

The server computer system 120 may store a digital key that provides access to the non-fungible token on the blockchain network. In one or more embodiments, the server computer system 120 may store the key in a software wallet that may include, for example, an encrypted vault that has protection with a password and/or a seed phrase. In one or more embodiments, the server computer system 120 may store the key in an InterPlanetary File System (IPFS) that uses content identifiers (CIDs). In these embodiments, the CIDs may be hashed and the hashes may be stored, for example, in the database. To access the non-fungible token on the blockchain network, the CID hashes may be obtained from the database and used as a form of verification. In one or more embodiments, the key may be stored on a hardware wallet that may be encrypted and protected by a password or biometrics.

As mentioned, in one or more embodiments, the metadata may be stored off-chain. In these embodiments, the server computer system 120 may store the metadata in a location that may be identified using the Uniform Resource Identifier link stored inside the contract of the non-fungible token.

In one or more embodiments, the non-fungible token may be stored on the blockchain network to serve as an identifier that points to a location of the immutable evidence data. Put another way, the non-fungible token's smart contract may contain information that points to an off-chain location where the actual immutable evidence data is stored.

In one or more embodiments, the server computer system 120 may store the location of the non-fungible token, may store the unique token identifier of the non-fungible token, and/or may store a key used to access the non-fungible token on the blockchain network in a database in association with an identifier such as for example a name, an email address, an account number, an identifier of an automated teller machine, etc., where the identifier is associated with a customer who provided the consent stored as the immutable evidence data or is associated with one or more immutable evidence data providers. The server computer system 120 may additionally store the date of creation of the non-fungible token in the database.

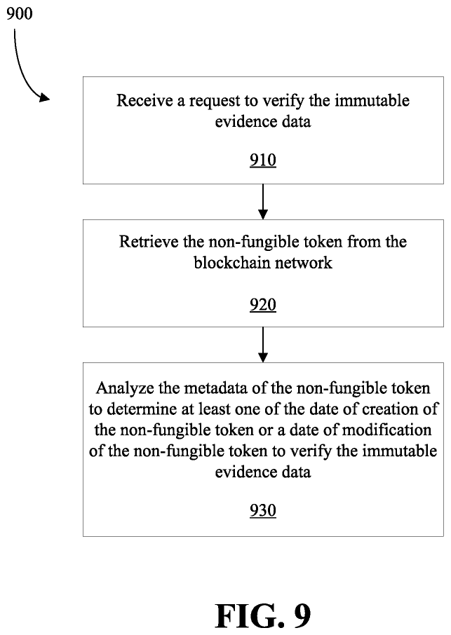

The non-fungible token may be used to verify immutable evidence data. Reference is made to FIG. 9, which illustrates, in flowchart form, a method 900 for verifying immutable evidence data. The method 900 may be implemented by a computing device having suitable processor-executable instructions for causing the computing device to carry out the described operations. The method 900 may be implemented, in whole or in part, by the server computer system 120.

The method 900 includes receiving a request to verify the immutable evidence data (step 910).

The request may be received from a computing system connected to the server computer system 120 and/or from an operator of the server computer system 120. The request may include an identifier such as for example a name, an email address, an account number, etc.

The server computer system 120 may perform a lookup using the identifier to determine the non-fungible token that is to be retrieved. For example, the server computer system 120 may use the email address to perform a lookup to determine the location of the non-fungible token.

The method 900 includes retrieving the non-fungible token from the blockchain network (step 920).

The server computer system 120 may retrieve the non-fungible token from the blockchain network. For example, the server computer system 120 may retrieve the location of the non-fungible token from the database and may retrieve the non-fungible token from the location. As another example, the server computer system 120 may obtain a key from the database that may be used to access the non-fungible token on the blockchain network.

The method 900 includes analyzing the metadata of the non-fungible token to determine at least one of the date of creation of the non-fungible token or a date of modification of the non-fungible token to verify the immutable evidence data (step 930).

The server computer system 120 accesses the metadata of the non-fungible token. The server computer system 120 may analyze the metadata to determine the date of creation of the non-fungible token and/or the date of modification of the non-fungible token and consequently may verify the immutable evidence data. For example, the date of the creation of the non-fungible token may be verified by comparing the metadata to the date of the creation stored in the database. When the date of the creation of the non-fungible token matches the date stored in the database this may indicate that the immutable evidence data has not been tampered with since it was minted as the non-fungible token. As such, the immutable evidence data is verified. As another example, the date of the creation of the non-fungible token may be different than the date of modification of the non-fungible token and as such the immutable evidence data is not verified since it has been modified since the non-fungible token was created. As another example, if the metadata indicates a date of modification of the non-fungible token this may indicate that the non-fungible token and/or the immutable evidence data has been modified and thus is not verified.

In manners described herein, the immutable evidence data may be retrieved and verified and may be used to resolve disputes that may arise.

As one example, a customer may raise a dispute indicating that they requested $100 from the automated teller machine 300 but only received $50 or may raise a dispute indicating that they deposited three (3) cheques with a total value of $300 but the automated teller machine 300 only deposited $200 into their account. In this example, the automated teller machine session data may be retrieved, verified and may then be reviewed to resolve the dispute.

As another example, the automated teller machine 300 may have applied potentially inappropriate or inaccurate service fees or foreign exchange premiums for transactions that rely on dynamic currency conversion or multi-currency dispensing. In this example, the automated teller machine session data may be retrieved, verified and may then be reviewed to resolve the potentially inappropriate or inaccurate service fees.

As yet another example, the automated teller machine session data may be stored as evidence of compliance to regulatory or contractual agreements with partners such as for example MasterCard™, VISA™, INTERAC™, etc.

As mentioned, the immutable evidence data may include consent data. In one example, the consent data may include data obtained from a mobile banking mobile application or website that includes permissions or consent granted within the mobile banking mobile application or website. The permissions may include, for example, a parent granting permission to their child to withdraw money from the automated teller machine 300. In this manner, the consent data may be retrieved together with the automated teller machine session data to resolve disputes.

As one example, a parent may raise a dispute based on their child withdrawing $100 from the automated teller machine 300. In this example, the automated teller machine session data and the consent data may be retrieved, verified and analyzed to determine whether or not the parent had used the mobile banking mobile application or website to grant permission to their child to withdraw the $100 from the automated teller machine 300.

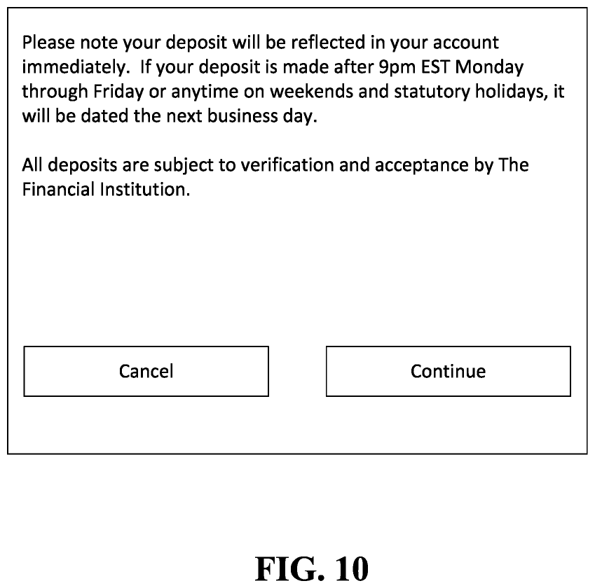

As mentioned, the immutable evidence data may include automated teller machine session data that may include, for example, screenshots, screen stills, images such as images of a cheque deposit, transaction receipt, etc. relating to tasks performed by the automated teller machine 300. Example screenshots, screen stills and images are shown in FIGS. 10 to 21.

Specifically, FIG. 10 is a screenshot that may be displayed during an automated teller machine session to receive customer acceptance of a disclosure statement. It will be appreciated that the automated teller machine session data may include the screenshot and data indicating which decision the customer made (continue or cancel).

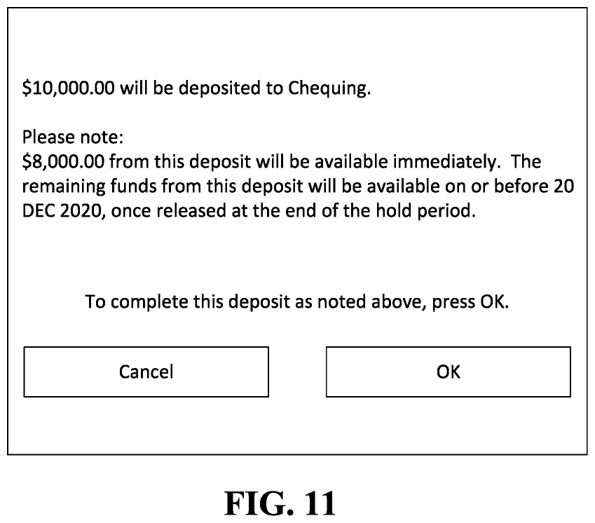

FIG. 11 is a screenshot that may be displayed during an automated teller machine session to receive customer acceptance of a disclosure statement. It will be appreciated that the automated teller machine session data may include the screenshot and data indicating which decision the customer made (“ok” or cancel).

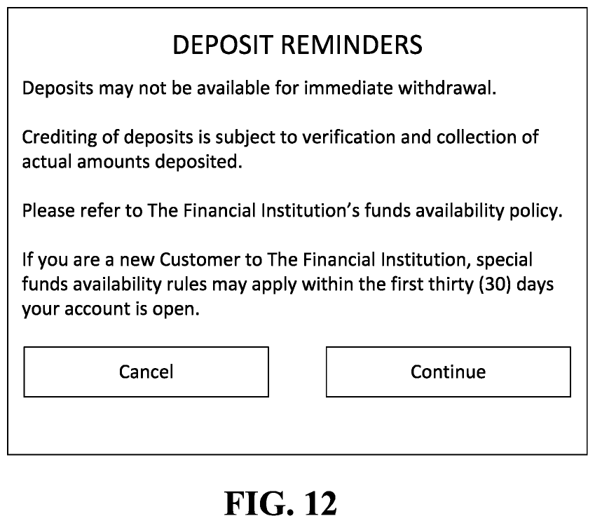

FIG. 12 is a screenshot that may be displayed during an automated teller machine session to receive customer acceptance of a disclosure statement. It will be appreciated that the automated teller machine session data may include the screenshot and data indicating which decision the customer made (continue or cancel).

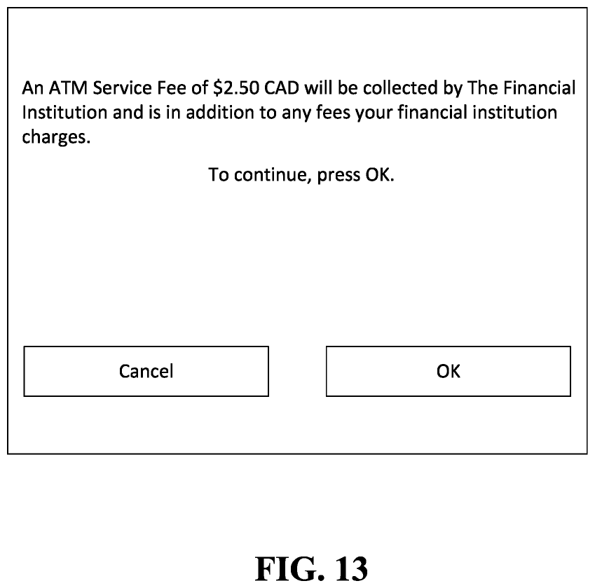

FIG. 13 is a screenshot that may be displayed during an automated teller machine session to receive customer acceptance of a service fee. It will be appreciated that the automated teller machine session data may include the screenshot and data indicating which decision the customer made (“ok” or cancel).

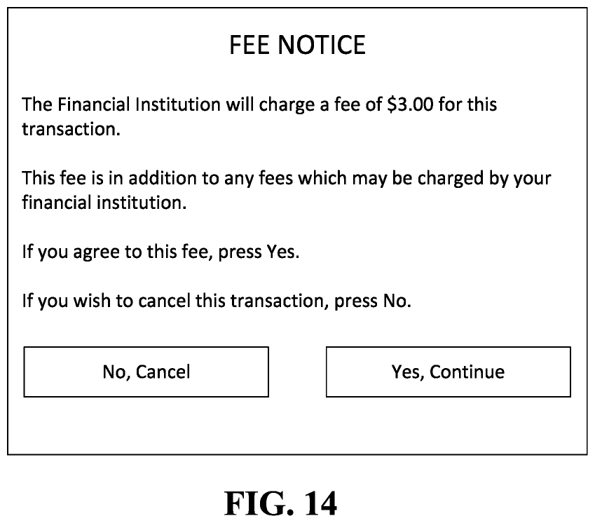

FIG. 14 is a screenshot that may be displayed during an automated teller machine session to receive customer acceptance of a service fee. It will be appreciated that the automated teller machine session data may include the screenshot and data indicating which decision the customer made (“no, cancel” or “yes, continue”).

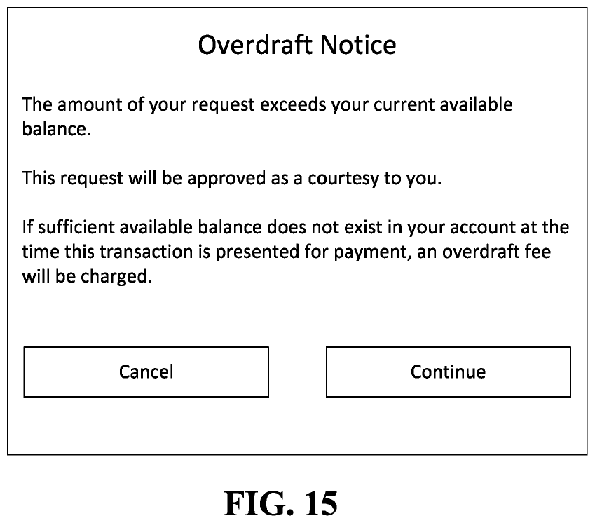

FIG. 15 is a screenshot that may be displayed during an automated teller machine session to receive customer acceptance of an overdraft fee. It will be appreciated that the automated teller machine session data may include the screenshot and data indicating which decision the customer made (cancel or continue).

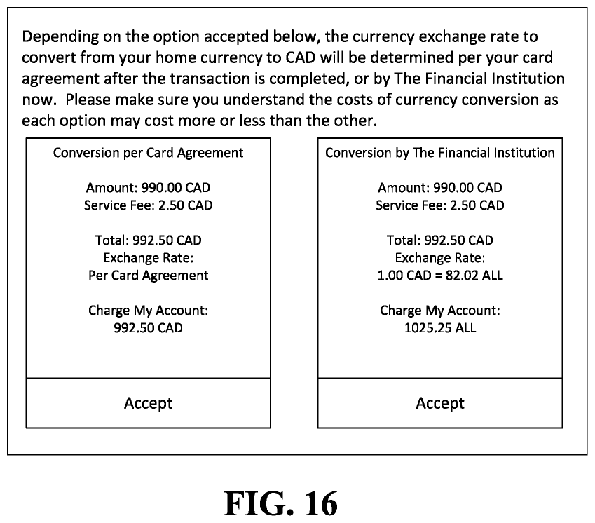

FIG. 16 is a screenshot that may be displayed during an automated teller machine session to receive customer selection of an exchange rate. It will be appreciated that the automated teller machine session data may include the screenshot and data indicating which decision the customer made (conversion per card agreement or conversion by the financial institution).

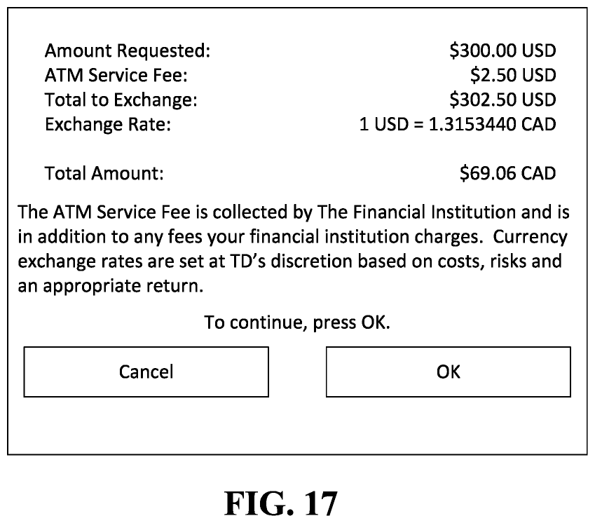

FIG. 17 is a screenshot that may be displayed during an automated teller machine session to receive customer acceptance of an exchange rate and service fee. It will be appreciated that the automated teller machine session data may include the screenshot and data indicating which decision the customer made (cancel or “ok”).

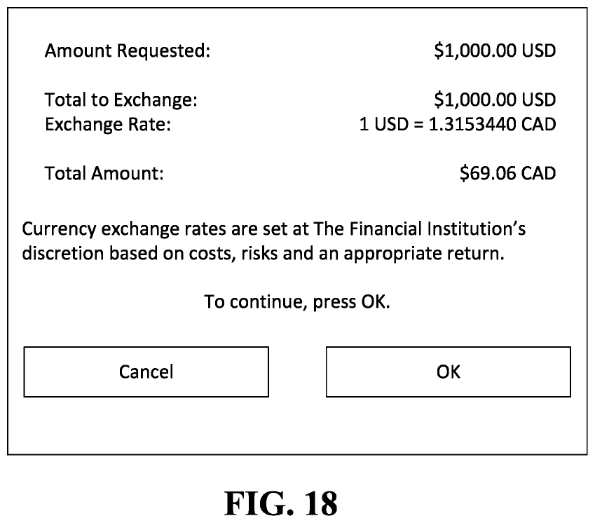

FIG. 18 is a screenshot that may be displayed during an automated teller machine session to receive customer acceptance of an exchange rate. It will be appreciated that the automated teller machine session data may include the screenshot and data indicating which decision the customer made (cancel or “ok”).

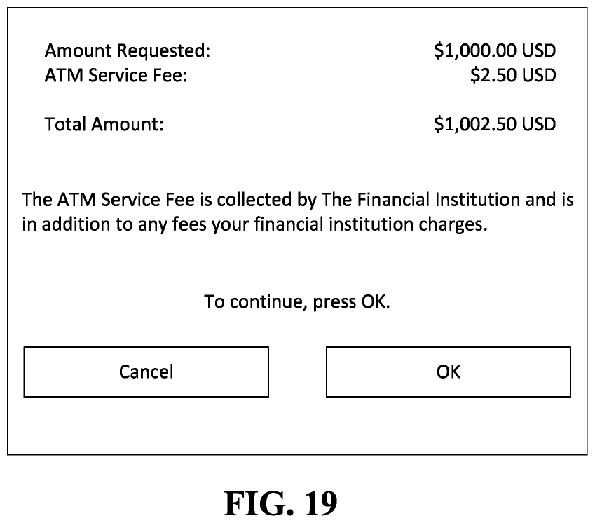

FIG. 19 is a screenshot that may be displayed during an automated teller machine session to receive customer acceptance of a service fee. It will be appreciated that the automated teller machine session data may include the screenshot and data indicating which decision the customer made (“cancel or “ok”).

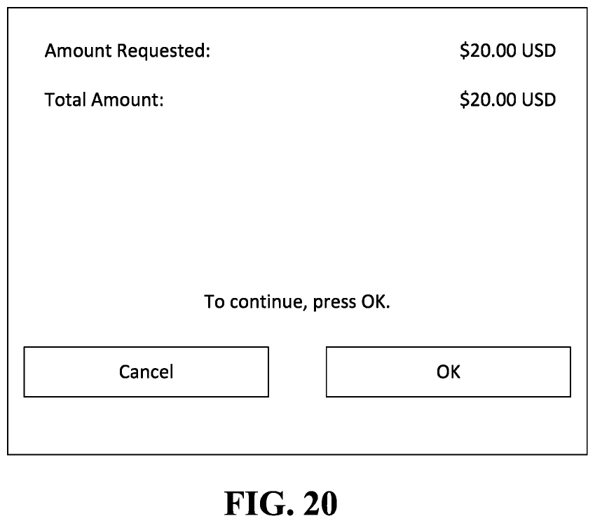

FIG. 20 is a screenshot that may be displayed during an automated teller machine session to receive customer confirmation of a withdrawal. It will be appreciated that the automated teller machine session data may include the screenshot and data indicating which decision the customer made (“cancel or “ok”).

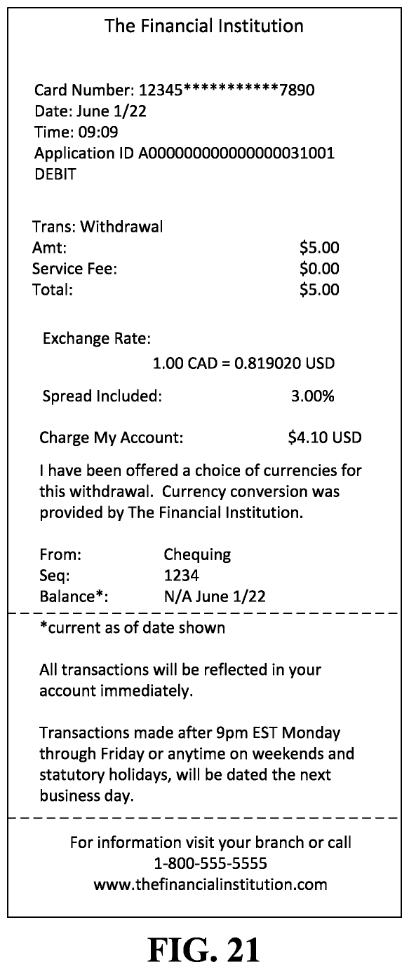

FIG. 21 is an image of a receipt that may be provided to a customer at the end of an automated teller machine session. The automated teller machine session data may include the image of the receipt.

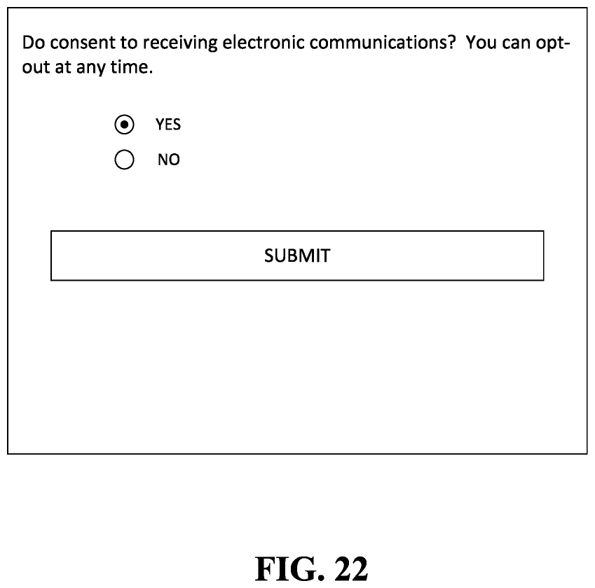

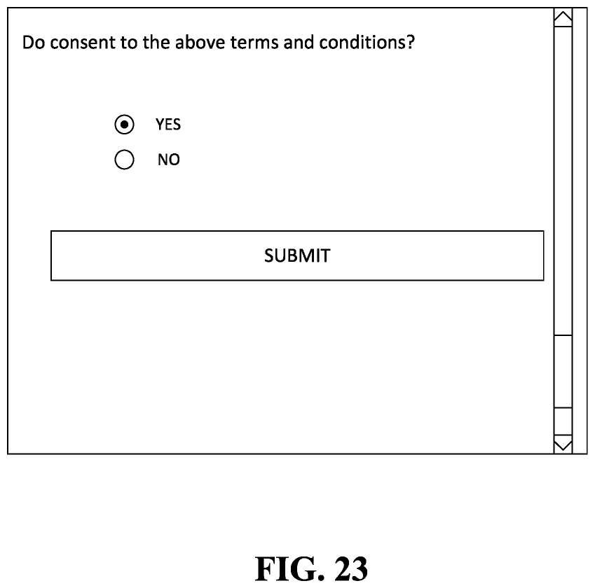

As mentioned, the immutable evidence data may include consent data that may include, for example, screenshots, screen stills, videos, etc. of a user providing consent such as for example opt-in consent. Example screenshots and screen stills are shown in FIG. 22 and FIG. 23.

FIG. 22 is a screenshot of a consent page showing that the user has indicated opt-in consent to receive electronic communications.

FIG. 23 is a screenshot of a terms and conditions page showing that the user has indicated consent to the terms and conditions.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A server computer system comprising:
a communications module;
a processor coupled to the communications module; and
a memory coupled to the processor, the memory storing processor-executable instructions which, when executed, configure the processor to:
obtain, via the communications module, immutable evidence data;
mint the immutable evidence data as a non-fungible token that includes metadata identifying at least a date of creation of the non-fungible token; and
store the non-fungible token in a block of a blockchain network.

2. The server computer system of claim 1, wherein the metadata is stored off-chain.

3. The server computer system of claim 1, wherein the metadata is stored as a Uniform Resource Identifier link inside a contract of the non-fungible token.

4. The server computer system of claim 1, wherein the metadata includes information identifying a date of modification of the non-fungible token.

5. The server computer system of claim 1, wherein when minting the immutable evidence data as the non-fungible token, the instructions, when executed, further configure the processor to:
create a new token having a unique token identifier; and
associate the new token with the metadata.

6. The server computer system of claim 1, wherein the instructions, when executed, further configure the processor to:
receive a request to verify the immutable evidence data;
retrieve the non-fungible token from the blockchain network; and
analyze the metadata of the non-fungible token to determine at least one of the date of creation of the non-fungible token or a date of modification of the non-fungible token to verify the immutable evidence data.

7. The server computer system of claim 1, wherein the non-fungible token includes a static non-fungible token.

8. The server computer system of claim 1, wherein the immutable evidence data includes at least one of consent data or automated teller machine session data.

9. The server computer system of claim 1, wherein the immutable evidence data includes automated teller machine session data and the automated teller machine session data is obtained, via the communications module, from at least one automated teller machine data source that includes at least one of an automated teller machine, an automated teller machine switch, and an automated teller machine host server.

10. The server computer system of claim 9, wherein the at least one automated teller machine data source includes a plurality of automated teller machine data sources and the processor-executable instructions, when executed, further configure the processor to:
normalize and aggregate the automated teller machine session data.

11. The server computer system of claim 10, wherein when aggregating the automated teller machine session data, the processor-executable instructions, when executed, further configure the processor to:
analyze the automated teller machine session data to identify at least one commonality within the automated teller machine session data received from each of the automated teller machine data sources; and
aggregate the automated teller machine session data based at least on the identified commonality.

12. A computer-implemented method performed by a processor of a server computer system, the method comprising:
obtaining, via a communications module, immutable evidence data;
minting the immutable evidence data as a non-fungible token that includes metadata identifying at least a date of creation of the non-fungible token; and
storing the non-fungible token in a block of a blockchain network.

13. The computer-implemented method of claim 12, wherein the metadata is stored off-chain.

14. The computer-implemented method of claim 12, wherein the metadata is stored as a Uniform Resource Identifier link inside a contract of the non-fungible token.

15. The computer-implemented method of claim 12, wherein the metadata includes information identifying a date of modification of the non-fungible token.

16. The computer-implemented method of claim 12, wherein when minting the immutable evidence data as the non-fungible token, the method further comprises:
creating a new token having a unique token identifier; and
associating the new token with the metadata.

17. The computer-implemented method of claim 12, further comprising:
receiving a request for the immutable evidence data;
retrieving the non-fungible token from the blockchain network; and
analyzing the non-fungible token to determine at least one of the date of creation of the non-fungible token or a date of modification of the non-fungible token.

18. The computer-implemented method of claim 12, wherein the immutable evidence data includes at least one of consent data or automated teller machine session data.

19. The computer-implemented method of claim 12, wherein the immutable evidence data includes automated teller machine session data and the automated teller machine session data is obtained, via the communications module, from at least one automated teller machine data source that includes at least one of an automated teller machine, an automated teller machine switch, and an automated teller machine host server.

20. A non-transitory computer-readable storage medium storing instructions that when executed by a processor of a computing system cause the computing system to:
obtain, via a communications module, immutable evidence data;
mint the immutable evidence data as a non-fungible token that includes metadata identifying at least a date of creation of the non-fungible token; and
store the non-fungible token in a block of a blockchain network.
